(19) United States
(12) Patent Application Publication
(10) Pub. No.: US 2025/0315241 A1
(43) Pub. Date: Oct. 9, 2025

(54) SEAMLESSLY IMPLEMENTING CODE MODULE UPDATES

(71) Applicant: International Business Machines Corporation, Armonk, NY (US)

(72) Inventor: Pierre Toussaint, Gatineau (CA)

(21) Appl. No.: 18/628,455

(22) Filed: Apr. 5, 2024

(51) Int. Cl. G06F 8/65

(52) U.S. Cl. CPC G06F 8/65

(57) ABSTRACT

A computer-implemented method, according to one approach, includes: receiving, from a user, an identification and a Uniform Resource Locator of a first module to be updated in an Integrated Development Environment. The ID and URL for the first module are stored in local storage. Moreover, in response to the first module being updated in the IDE, a websocket message with a new URL for the updated first module is automatically received. The websocket message is further used to initiate an updating process for the updated first module.

### STATEMENT REGARDING PRIOR DISCLOSURES BY THE INVENTOR OR A JOINT INVENTOR

The following disclosure is submitted under 35 U.S.C. 102(b)(1)(A): DISCLOSURE: “Accelerating extension development in IBM Cognos Analytics,” Pierre Toussaint, Medium.com, Oct. 9, 2023.

### BACKGROUND

The present invention relates to computer code, and more specifically, this invention relates to seamlessly performing code modifications.

Computer “code” refers to the set of instructions, or a system of rules, written in a particular programming language. Code can also refer to source code after it has been processed by a compiler and made ready to run on the computer. In addition to building computer programs and mobile applications, code is used heavily for innovative concepts such as artificial intelligence and machine learning.

Although code is developed in a particular configuration and/or for a particular application, it can be updated over time. An update to the code involves performing changes to the code itself that impact how the code operates. In other words, new code is used to replace older versions of the same code. These changes to the software are usually performed to fix bugs, address security vulnerabilities, provide new features, etc. For example, updating your operating system brings it up-to-date with the latest drivers, system utilities, and security software.

While performing updates to code allows for the code to adapt over time, updates are also a source of operating strain. For example, conventional products have struggled with replacing code seamlessly and reliably, particularly while attempting to replace references to a piece of code after it has been updated.

### SUMMARY

A computer-implemented method (CIM), according to one approach, includes: receiving, from a user, an identification (ID) and a Uniform Resource Locator (URL) of a first module to be updated in an Integrated Development Environment (IDE). The ID and URL for the first module are stored in local storage. Moreover, in response to the first module being updated in the IDE, a websocket message with a new URL for the updated first module is automatically received. The websocket message is further used to initiate an updating process for the updated first module.

A computer program product (CPP), according to another approach, includes: a set of one or more computer-readable storage media. The CPP also includes program instructions that are collectively stored in the set of one or more storage media and for causing a processor set to perform the foregoing CIM.

A computer system (CS), according to yet another approach, includes: a processor set, and a set of one or more computer-readable storage media. The CS further includes program instructions that are collectively stored in the set of one or more storage media and for causing the processor set to perform the foregoing CIM.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3A is a flowchart of a method, in accordance with one approach.

FIG. 3B is a flowchart of sub-operations for one of the operations in the method of FIG. 3A, in accordance with one approach.

FIG. 4A is a representational view of a flowchart, in accordance with an “on-demand” in-use example.

FIG. 4B is a representational view of a flowchart, in accordance with an “automatic” in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for dynamically replacing one or more updated modules of code, including any dependent modules that reference the updated modules, without refreshing the corresponding implementation of the code, e.g., such as an underlying browser page. Approaches herein are thereby able to increase efficiency of the development cycle while working with code updates in different frameworks. This is achieved, at least in part, by loading the new version of a module and using it to patch the previous versions which are, as a consequence, preserved. Moreover, this process can be performed either automatically or on-demand. The patch operation allows existing dependencies to consume the updated version of the module without considering any dependency trees. This process may also be executed without interfering with the state of the underlying page, resulting in there being no refresh of the page, nor re-draw of the UI. Additionally, in situations where a module of code is updated in asynchronous module definition (AMD), modules that reference the now-obsolete module of code are desirably modified to reference the updated version of the module, e.g., as will be described in further detail below.

In one general approach, a CIM includes: receiving, from a user, an identification (ID) and a Uniform Resource Locator (URL) of a first module to be updated in an Integrated Development Environment (IDE). The ID and URL for the first module are stored in local storage. Moreover, in response to the first module being updated in the IDE, a websocket message with a new URL for the updated first module is automatically received. The websocket message is further used to initiate an updating process for the updated first module.

In another general approach, a CPP includes: a set of one or more computer-readable storage media. The CPP also includes program instructions that are collectively stored in the set of one or more storage media and for causing a processor set to perform the foregoing CIM.

In yet another general approach, a CS includes: a processor set, and a set of one or more computer-readable storage media. The CS further includes program instructions that are collectively stored in the set of one or more storage media and for causing the processor set to perform the foregoing CIM.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved module update code at block 150 for dynamically replacing one or more updated modules of code, including any dependent modules that reference the updated modules, without refreshing the corresponding implementation of the code, e.g., such as an underlying browser page. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

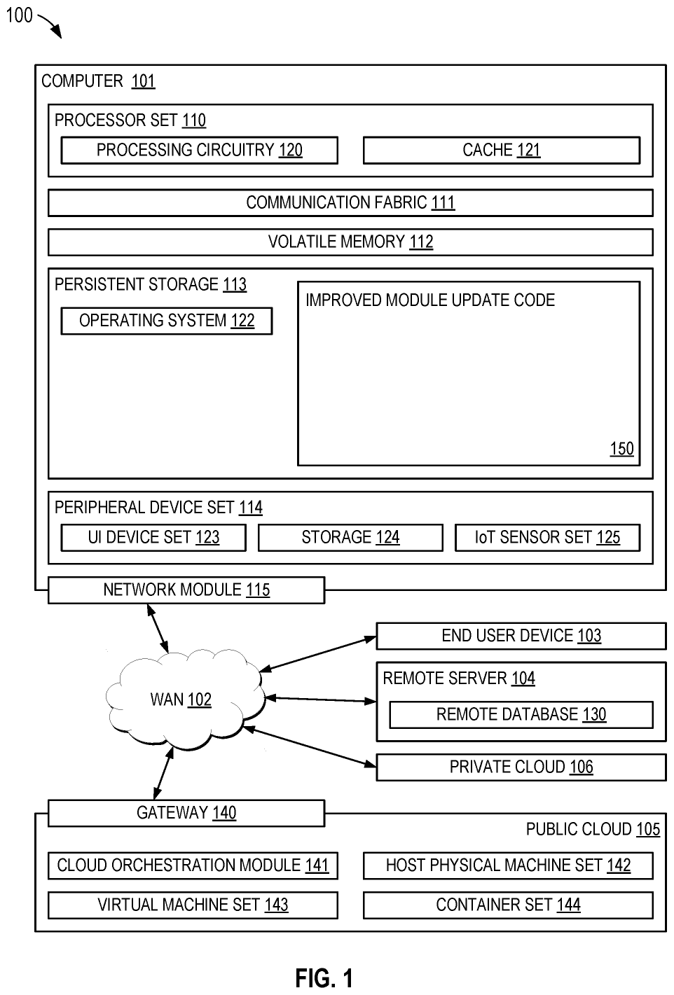

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on-demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, computer code refers to the set of instructions, or a system of rules, written in a particular programming language, also referred to as “source code.” Code is also the term used for the source code after it has been processed by a compiler and made ready to run on the computer. In addition to building computer programs and mobile applications, code is used heavily for innovative concepts such as artificial intelligence and machine learning.

Although code is developed in a particular configuration and/or for a particular application, it can be updated over time. An update to the code involves performing changes to the code itself that impact how the code operates. In other words, new code is used to replace older versions of the same code. These changes to the software are usually performed to fix bugs, address security vulnerabilities, provide new features, etc. For example, updating your operating system brings it up-to-date with the latest drivers, system utilities, and security software.

While performing updates to code allows for the code to adapt over time, updates are also a source of operating strain. For example, conventional products have struggled with replacing code seamlessly and reliably, particularly while attempting to replace references to a piece of code after it has been updated. This is particularly true for certain technologies, e.g., such as frameworks that implement JavaScript™ modules in a browser engine to process them. These conventional products are unable to replace modules, and update references to the replaced modules, without refreshing the underlying page. Conventional products are thereby forced to perform a significant number of page refreshes in an attempt to successfully implement code updates, resulting in a significant impact on available compute resources.

In sharp contrast, approaches herein increase efficiency of the development cycle while working with code updates in different frameworks. These approaches load the new version of a module and use it to patch the previous versions which are, as a consequence, preserved. Moreover, this process can be performed either automatically or on-demand. The patch operation allows existing dependencies to consume the updated version of the module without considering any dependency trees. This process may also be executed without interfering with the state of the underlying page, resulting in there being no refresh of the page, nor re-draw of the UI. Additionally, in situations where a module of code is updated in AMD, all modules that reference the now-obsolete module of code are desirably modified to reference the updated version of the module. Again, conventional products are simply unable to perform any updates of the reference that dependent modules make to a module (e.g., section of code) after it has been updated without first performing one or more page refreshes.

While a number of approaches are described in the context of using frameworks that implement JavaScript™ modules in a browser engine to process them, this is in no way intended to be limiting. Approaches herein may thereby be used to perform code updates in other programming languages. It should also be noted that the term “module” is intended to refer to the granularity of code that can be changed (e.g., updated), and each module further corresponds to a respective file, e.g., as would be appreciated by one skilled in the art after reading the present description.

Approaches herein are able to perform module updates on the fly regardless of the number of modules being updated. For instance, approaches are able to perform “bundling” by loading multiple files at a time, thereby allowing for multiple modules to be defined together, rather than issuing a command for each file/module pair. However, a single module may be updated using any of the approaches herein.

Approaches are also able to load modules individually, even in situations where the modules are bundled together. This avoids working with unbundled source files, thereby further simplifying the development setup, and significantly impacting corresponding loading times. Approaches herein can also be achieved without implementing specific API(s), and can even work with a simple proxy server. These approaches take advantage of the fact that some code (e.g., like JavaScript™) operates as a prototype based language in order to ensure that all existing object instances pointing to the prototype of a previously loaded version are updated without any additional refresh step(s), e.g., as will be described in further detail below.

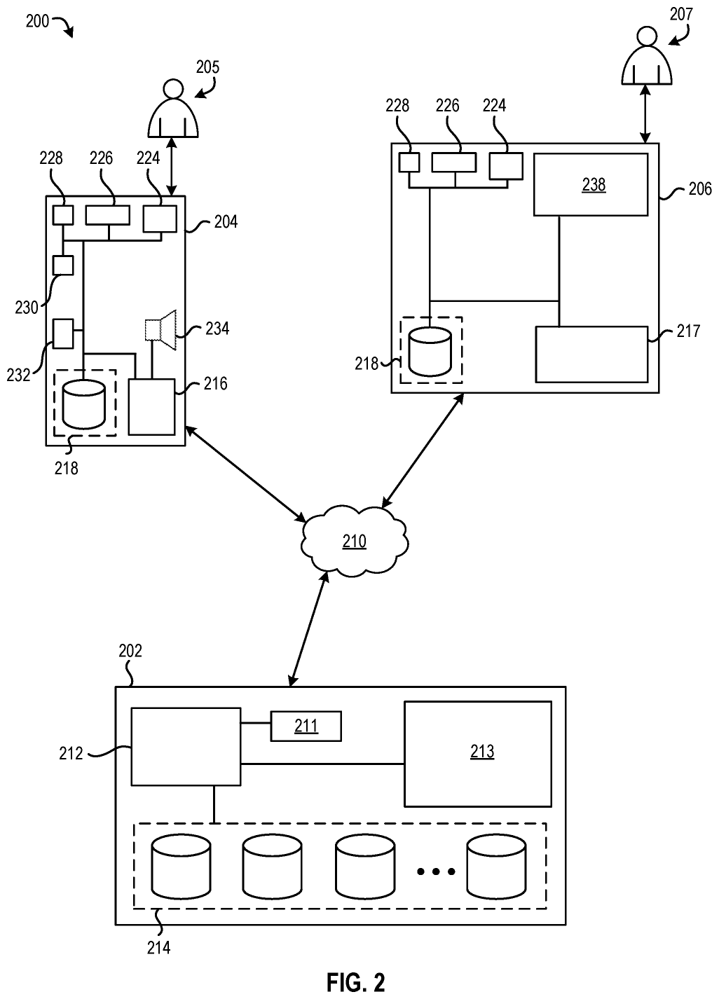

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to a user device 204, and edge node 206. The user device 204 is further accessible to the user 205, while the edge node 206 is assessable to developer 207. The user device 204 and/or the edge node 206 may thereby be considered “client devices,” each of which are connected to the central server 202. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations. According to some approaches, the central server 202 is a remote cloud server that is connected to (e.g., may be accessed by) user device 204 and/or edge node 206.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The terms “user” and “developer” are in no way intended to be limiting. For instance, while users and developers may be described as being individuals in various implementations herein, a user and/or a developer may be an application, an organization, a preset process, etc. in other approaches. The use of “data,” “datasets,” and “information” herein are in no way intended to be limiting either, and may include any desired type of details, e.g., depending on the type of operating system implemented on the user device 204, edge node 206, and/or central server 202.

With continued reference to FIG. 2, the central server 202 includes a large (e.g., robust) processor 212 coupled to a cache 211, an AI module 213, and a data storage array 214 having a relatively high storage capacity. The AI module 213 may include any desired number and/or type of AI-based models, e.g., such as machine learning models, deep learning models, neural networks, etc. In preferred approaches, the AI module 213 includes models that have been trained to assist in updating code modules as described in the approaches herein. For instance, the AI module 213 preferably includes an AI based model that has been trained to identify references (e.g., pointers) in code to one or more modules being replaced.

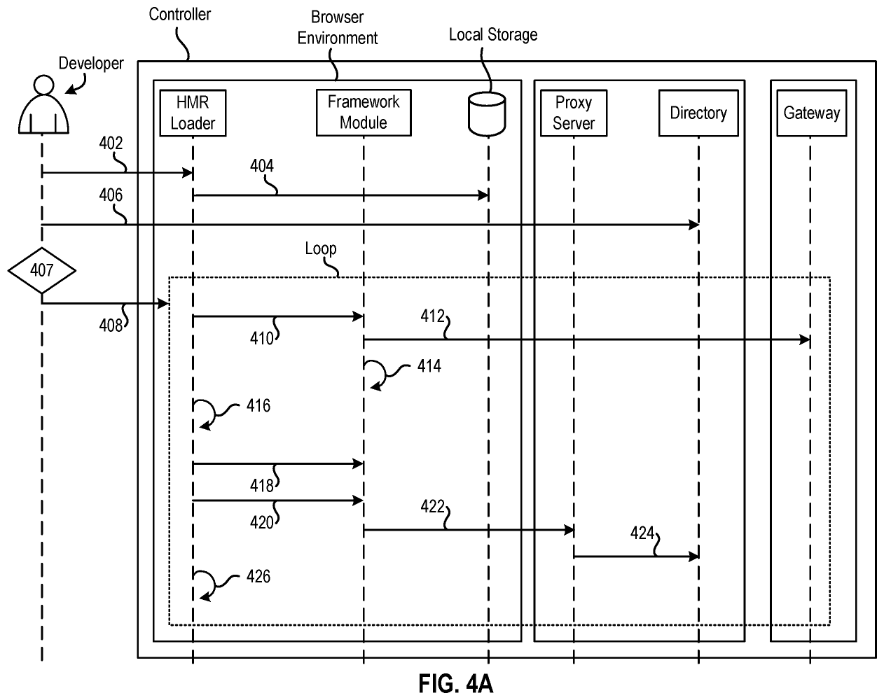

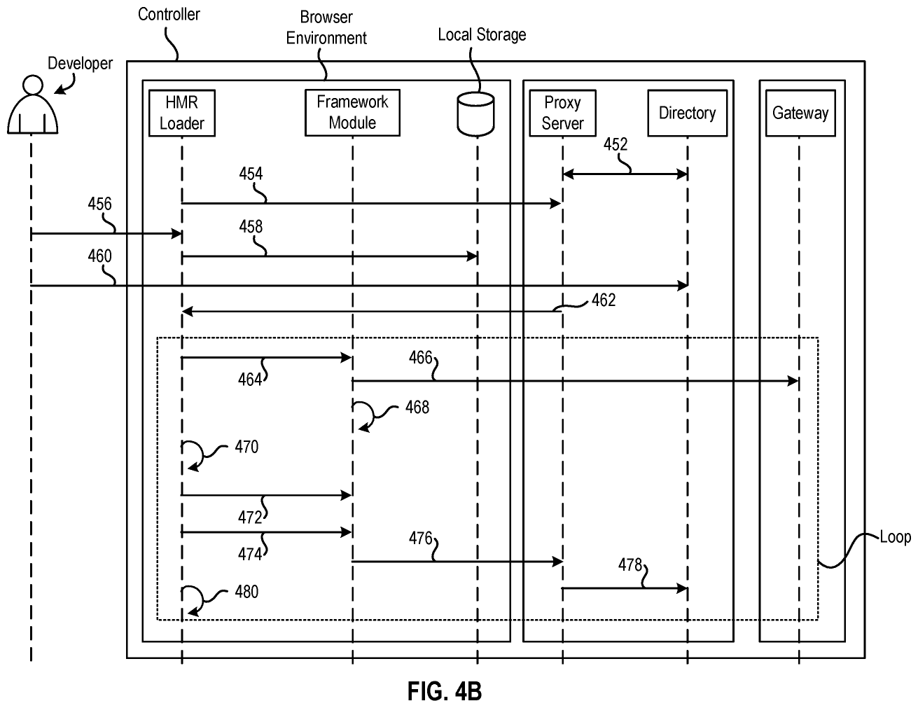

In some approaches, the AI module 213 may work along with processor 212 to perform updates on code modules. For instance, the AI module 213 and/or processor 212 may include components and functionality that allow for a browser and developer environments to be formed and used. The browser environment (not shown here) may include a hot module replacement (HMR) loader, a framework module implementing AMD, and local storage. Moreover, the developer environment may include a proxy server as well as a directory that includes code module sources. The components of the browser and developer environments are preferably configured to communicate with each other, as well as an application that includes the code modules being updated. For non-limiting examples, see FIGS. 4A-4B below. These components and environments are also preferably accessible to a developer that interacts and controls the progression, e.g., as will be described in further detail below.

With continued reference to FIG. 2, user device 204 includes a processor 216 which is coupled to memory 218. The processor 216 receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

In some approaches, data modifications may be submitted by user 205 using user device 204 and central server 202. For instance, updates to data that includes non-sensitive topics and/or data may be received from user 205 through user device 204 for storage in memory of data storage array 214. The updates may be received as a result of the user 205 using one or more applications, software programs, temporary communication connections, etc., that may be running on the user device 204. For example, the user 205 may use user device 204 to enter (e.g., type) new content into a file and upload the new content to be added to the existing data in memory of the data storage array 214 at central server 202.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238. As described above with respect to AI module 213, the AI module 238 may include any desired number and/or type of AI-based models, e.g., such as machine learning models, deep learning models, neural networks, etc. However, in preferred approaches the AI module 238 includes models that have been trained to seamlessly perform updates on code modules. For instance, the AI module 238 and/or controller 217 may include components and functionality that allow for a browser and developer environments to be formed and used. AI module 238 and/or controller 217 (and similarly AI module 213 and/or processor 212) may thereby be used to perform one or more of the operations in method 300 below to perform code module updates in a most efficient and accurate way possible, e.g., as will be described in further detail below.

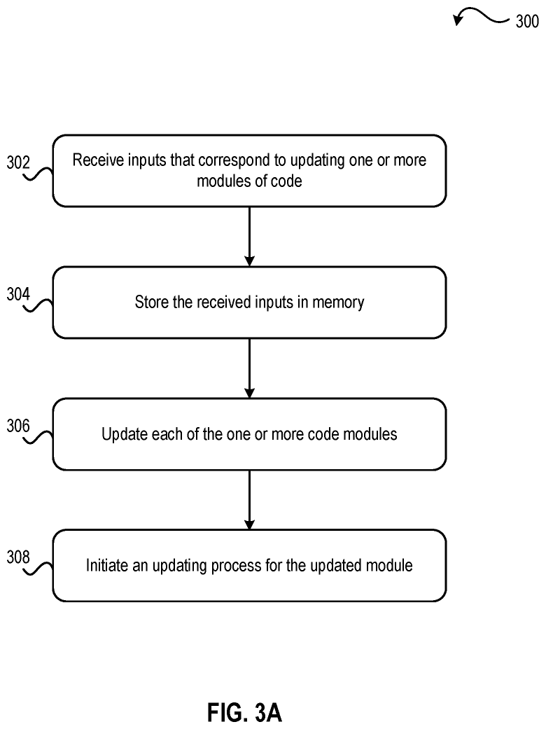

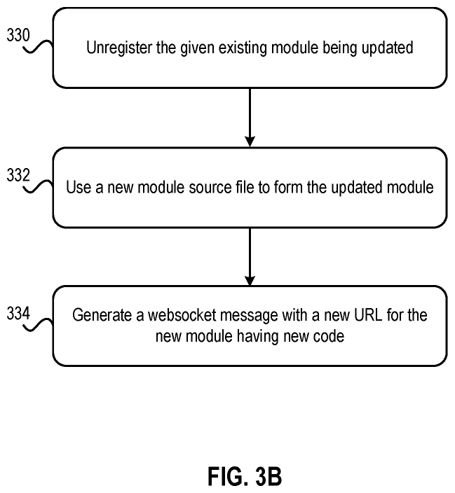

Looking now to FIG. 3A, a flowchart of a computer-implemented-method 300 for dynamically replacing one or more updated modules of code, including any dependent modules that reference the updated modules, without refreshing a corresponding page is illustrated in accordance with one approach. In other words, method 300 includes updating code without refreshing the underlying implementation of the code (e.g., representation in a browser page). The method 300 may be performed in accordance with the present invention in any of the environments depicted in FIGS. 1-2, among others, in various embodiments. Of course, more or less operations than those specifically described in FIG. 3A may be included in method 300, as would be understood by one of skill in the art upon reading the present descriptions.

Each of the steps of the method 300 may be performed by any suitable component of the operating environment. For example, in some approaches one or more of the operations in method 300 may be performed by a controller configured to implement browser and developer environments (e.g., see controller 217 and/or processor 212 FIG. 2), which may be supplemented by an AI based module (e.g., see AI modules 213 and/or 238 of FIG. 2). However, the method 300 may be partially or entirely performed by a controller, a processor, a computer, etc., or some other device having one or more processors therein. Moreover, the terms computer, processor and controller may be used interchangeably with regards to any of the embodiments herein, such components being considered equivalents in the many various permutations of the present invention.

For those embodiments having a processor, the processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a FPGA, an AIU, a GPU, etc., combinations thereof, or any other suitable computing device known in the art.

As shown, operation 302 includes receiving inputs that correspond to updating one or more modules of code. In other words, operation 302 includes receiving information (e.g., instructions, commands, metadata, etc.) that corresponds to performing a code update of varying size. Depending on the approach, the code update may be intended to add a feature to a software program that corresponds to the code, address an issue identified in the code, reflect previous performance, to reflect results generated by machine learning models based on evaluation(s) performed on data, etc. Accordingly, the inputs received in operation 302 are typically received from a user (e.g., a developer), they may be received from one or more running applications, machine learning models, pre-programmed rules, etc. It also follows that the number of code modules that are ultimately updated as a result of receiving the inputs may vary.

The information received in operation 302 is preferably sufficient to identify the one or more code modules that are intended to be updated. According to preferred approaches, the inputs include an identification (ID) and a Uniform Resource Locator (URL) for each of the modules being updated. The modules being updated may correspond to an Integrated Development Environment (IDE). Accordingly, the IDs and URLs that may be received in operation 302 are preferably compatible with an IDE constructed to implement the code updates.

In response to receiving the inputs, method 300 advances from operation 302 to operation 304. There, operation 304 includes storing the received inputs in memory. As noted above, the inputs preferably include a unique ID and URL pair for each respective code module being updated. The ID and URL pairs may be stored in local storage in some approaches, e.g., to increase accessibility and reduce latency. The inputs may be stored in a lookup table that incorporates each module of code in an organized fashion in some approaches. In some approaches the inputs are incorporated in and/or transformed into an AMD format, but any desired format may be used to save the received inputs. The IDE may thereby be configured to use (e.g., update) one or more AMD based modules, e.g., as would be appreciated by one skilled in the art after reading the present description. It should also be noted that the IDE may be configured differently depending on the approach. For instance, in some approaches the IDE is configured to implement JavaScript® software development, which is in no way intended to be limiting. Accordingly, IDE may be configured to implement an API that allows for interfacing with the code itself, e.g., such as requireJS.undef which again is in no way intended to be limiting.

While one or more specific modules of code may be identified by the inputs received in operation 302, operation 306 includes actually updating the one or more code modules. In other words, performing operation 306 involves causing the code modules to be updated as requested. In addition to identifying the code modules being updated, the inputs received in operation 302 may also outline how the modules are to be updated. The inputs may thereby include new code, instructions on how to update existing code, metadata outlining additional details, etc.

Referring momentarily to FIG. 3B, exemplary sub-operations of updating the one or more code modules are illustrated in accordance with an “automatic” configuration. It follows that one or more of these sub-operations may be implemented as a result of and/or as part of performing operation 306 in FIG. 3A for code modules that are updated automatically. However, it should be noted that the sub-operations of FIG. 3B are illustrated in accordance with one approach which is in no way intended to be limiting. It should also be noted that the sub-operations of FIG. 3B may be repeated for each code module identified for updating. Thus, in approaches involving updating bundles of modules, the sub-operations may be repeated in an iterative fashion. In other approaches (e.g., “on demand” configurations), one or more of the sub-operations may not be performed.

Sub-operation 330 includes unregistering the given existing module being updated. In other words, sub-operation 330 includes removing a present one of the existing modules such that it may not be accessed during the updating process. In some approaches, each existing module may be unregistered using requireJS.undef. However, existing modules in other formats may be unregistered using other processes that would be apparent to one skilled in the art after reading the present description.

Proceeding to sub-operation 332, the new module source is used to form the updated module. The new module source may be a file that has been retrieved in the IDE and used to form the updated module in some approaches. In other words, a new module is retrieved to serve as the new updated module in place of (e.g., replacing) the corresponding existing module. In some approaches, the source file of the new module is retrieved using force fetching. The new module may be retrieved from a buffer of available modules in some approaches. New code may be written to the new module as part of performing sub-operation 332. Accordingly, a complete (e.g., operationally sound) new module may be produced as a result of performing sub-operation 332, e.g., using the inputs initially received. Furthermore, sub-operation 334 includes generating a websocket message with a new URL for the new module having new code in “automatic” configurations. This websocket message may thereby be used in “automatic” configurations in which code modules are automatically updated to replace references to the existing module, and establish references to the new code in the new module. This desirably maintains the integrity of the code and operation of the underlying application, e.g., as would be appreciated by one skilled in the art after reading the present description. The websocket may further be used to keep track in memory of all the versions of code modules that have been previously loaded by any dependency, and for each to update their prototype. As a result, dependencies use the new code, after which the new version(s) are registered as a “future old” versions, thereby allowing additional update operations to be performed. Again, websockets are used in “automatic” configurations in which an update of a module performed and saved in the IDE is automatically pushed to the running environment (e.g., browser). However, it should be noted that in “on demand” configurations a websocket may not be used to update the code modules, as will be described in further detail below (e.g., see FIG. 4A).

The websocket message and new URL for the new module may be used while updating each reference to the first module with the new module source file in the IDE. Sub-operation 334 may thereby include identifying each dependency that stems from an existing module, and converting those dependencies to refer to the new module formed in operation 332. It follows that in approaches where the code modules correspond to a URL, each reference to the existing module found in the URL is replaced with the new module source file in the IDE.

Returning now to FIG. 3A, method 300 advances from operation 306 in response to each module that is updated. As noted above, one or more modules may ultimately be updated in response to inputs that are received from a developer. Accordingly, operation 306 (and/or other operations) may be repeated for each module that is updated. There, operation 306 includes automatically receiving a websocket message with a new URL for the updated module from the IDE. Again, the websocket message may be used to replace references to the existing module, and establish references to the new code in the new module formed.

Accordingly, operation 308 includes initiating an updating process for the updated module. In other words, operation 308 includes replacing references to the now-outdated original module, with references to the correlated new code in a new module. In some approaches, received websockets may be used to perform operation 308. Moreover, each websocket message may correspond to updating a single module. In other approaches, websocket messages may incorporate each module in a bundle. The websocket message(s) may thereby be used to initiate the updating process for any desired number of updated modules.

In some approaches, replacing references to the now-outdated original module includes It follows that method 300 is able to dynamically replace any desired number of updated code modules, including any dependent modules that reference the updated modules, without refreshing a corresponding page. Approaches herein are thereby able to update code automatically without refreshing the underlying implementation of the code (e.g., representation in a browser page).

However, it should be noted that in some approaches it may be preferred that module updates are reviewed before being implemented in the existing code. Accordingly, in some approaches a determination may be made as to whether each module modification should be fully implemented in the existing code or not. Looking now to FIG. 4A, a nonlimiting “on-demand” in-use example is depicted. This on-demand configuration may be used in situations where a user (e.g., developer) wishes to perform operational testing on proposed module modifications before approving them for implementation. This may provide the user with an opportunity to address issues and ensure successful performance when implemented in (e.g., added to) existing code. It should also be noted that module updates that are implemented are done so without refreshing the underlying rendering of the code (e.g., page and/or UI) as described above.

As shown at operation 402, a Developer initiates a module update by submitting inputs to an HMR Loader in the Browser Environment. For instance, the Developer may submit the ID and/or source path of the module being updated. The Browser Environment also includes a Framework Module implementing AMD and Local Storage. These elements in the Browser Environment are accessible to the Developer and are also configured to communicate with other elements implemented in the Controller. For instance, elements in the Browser Environment are able to communicate with the Developer Environment and even the Application in some approaches.

In response to receiving the inputs from the Developer, the HMR Loader saves the inputs in the Local Storage. See operation 404. Thereafter, one or more of the existing code modules are updated by the Developer, e.g., as outlined in the initial inputs received by the HMR Loader. As shown in operation 406, the updates to the modules are submitted to a Directory in the Developer Environment. The Directory preferably includes the existing modules (e.g., module sources) and may thereby be configured to implement (e.g., cause) the updates requested by the Developer.

In response to the updates being made to one or more of the modules, the Developer is able to determine whether the updates should be replicated across the existing code modules. According to one example, it may be desirable for the Developer to make updates to code modules for testing purposes before implementing in the main code base. Modules having updates that are approved by the Developer trigger the replacement of one or more modules of the existing code. Moreover, the replacements are triggered at the HMR Loader.

It follows that in some approaches, authorization is requested from the Developer before implementing any module updates. Authorization may be requested from the Developer in a number of ways depending on the approach. For instance, in some approaches requesting authorization from the user to initiate the updating process for a given updated module includes causing a display available to (e.g., in view of) the Developer to present at least one logical button configured to initiate the updating process in response to being activated by the user. In other approaches, a unique physical button and/or designated key on a keyboard may be configured such that the updating process is initiated for a present module in response to the Developer activating (e.g., depressing) the physical button. In still other approaches, a message may be transmitted to a personal device (e.g., mobile phone) of the Developer for approval or denial over e-mail, Short Message Service (SMS) messages, voice entries, etc. In situations where authorization is not received from the Developer, the modified module may simply be discarded, saved in storage (e.g., a buffer), used to generate a reminder sent to the Developer, etc.

In response to determining at operation 407 that the update should be implemented, operation 408 includes triggering the module replacement, e.g., such that a Loop is initiated in which each of the modules identified as having been updated are replaced. It follows that the Loop is repeated for each module approved by the Developer to be updated. The Loop includes the HMR Loader requesting the present module identified for update from the Framework Module. See operation 410. In situations where the requested module is not already loaded (e.g., in Local Storage and/or locally in cache), the module source is fetched from the Application Gateway, and registered. See operations 412, 414, respectively. A Reference to the Module Version is added to the HMR Loader. See operation 416. The HMR Loader further causes the requested module to be unregistered at the Framework Module. See operation 418. Moreover, the HMR Loader Force Fetches a new module source by submitting a request to the Framework Module. See operation 420. The Framework Module passes the fetch request to the Proxy Server at the Developer Environment (see operation 422), which may in turn retrieve the corresponding source file from the Directory (see operation 424). This information is preferably returned to the HMR Loader in response to the issued request. In response, the HMR Loader may update the prototype of each kept model version. See operation 426. In other words, the HMR Loader may replace each reference to the original (e.g., existing) version of the module, with an updated reference to the new code in the new module.

Looking now to FIG. 4B, a nonlimiting “automatic” in-use example is depicted. This automatic configuration is similar to method 300 of FIG. 3, and may be used in situations where a user (e.g., developer) wishes to automatically implement module updates such that code updates are further streamlined. This may provide the user an opportunity to see the impact of their updates in real-time. It should also be noted that the module updates are implemented and apparent to users without refreshing the underlying rendering of the code (e.g., page and/or UI), e.g., as described above.

As shown, the Proxy Serer and Directory in the Developer Environment are monitoring activity for code updates. See operation 452. In response to identifying a situation involving updates to one or more existing code modules, the HMR Loader submits a websocket connection to the Proxy Server. See operation 454. The websocket connection preferably establishes the communication between the browser and the proxy server. Accordingly, new URLs may be received from the Developer Environment. The new URLs are used to properly reference the new updated modules, e.g., as would be appreciated by one skilled in the art after reading the present description.

Thereafter, Developer submits inputs associated with to an HMR Loader in the Browser Environment. See operation 456. For instance, the Developer may submit the ID and/or source path of the module being updated. In response to receiving the inputs from the Developer, the HMR Loader saves the inputs in the Local Storage. See operation 458. Thereafter, one or more of the existing code modules are updated by the Developer, e.g., as outlined in the initial inputs received by the HMR Loader. As shown in operation 460, the updates to the modules are submitted to a Directory in the Developer Environment. The Directory preferably includes the existing modules (e.g., module sources) and may thereby be configured to implement (e.g., cause) the updates requested by the Developer.

In response to the updates being made to one or more of the modules, the Proxy Server automatically returns one or more messages to the HMR Loader with the source path of each module that has been modified. See operation 462. In response to receiving the message(s), a Loop is automatically initiated in which each of the modules identified as having been updated are replaced. It follows that the Loop is repeated for each module that has been updated as a result of the inputs received from the Developer. The Loop involves the HMR Loader triggering the replacement (see operation 464), followed by requesting the present module identified for update (see operation 466). In situations where the requested module is not already loaded (e.g., in Local Storage and/or locally in cache), the module source is fetched from the Application Gateway, and registered. See operation 468.

A Reference to the Module Version is added to the HMR Loader. See operation 470. The HMR Loader further causes the requested module to be unregistered at the Framework Module. See operation 472. Moreover, the HMR Loader Force Fetches a new module source by submitting a request to the Framework Module. See operation 474. The Framework Module passes the fetch request to the Proxy Server at the Developer Environment (see operation 476), which may in turn retrieve the corresponding source file from the Directory (see operation 478). This information is preferably returned to the HMR Loader in response to the issued request. In response, the HMR Loader may update the prototype of each kept model version. See operation 480. In other words, the HMR Loader may replace each reference to the original (e.g., existing) version of the module, with an updated reference to the new code in the new module.

Again, approaches herein are able to increase efficiency of the development cycle while working with code updates in different frameworks. This is achieved, at least in part, by loading the new version of a module and using it to patch the previous versions which are, as a consequence, preserved. Moreover, this process can be performed either automatically or on-demand. The patch operation allows existing dependencies to consume the updated version of the module without considering any dependency trees. This process may also be executed without interfering with the state of the underlying page, resulting in there being no refresh of the page, nor re-draw of the UI. Additionally, in situations where a module of code is updated in AMD, modules that reference the now-obsolete module of code are desirably modified to reference the updated version of the module.

These capabilities are achieved as a result of two main components: a client portion, and a server portion. With respect to the client (e.g., developer) portion, code responsible of keeping track of the previous versions of the modules and loading the new versions is maintained. Moreover, in order to load a module even when bundles of modules are used, another requireJS bundle may be dynamically defined for each module. In response to loading the new version of the module, each previous version is patched. Patching the previous versions may be achieved in situations where the module is a class by going through the properties of the prototype. However, in situations where the module is a simple object, its properties are processed directly, where the patch corresponds to assigning properties, the source being the new version and the target each previous one. The list of modules may also be stored in the browser local cache, allowing to preserve the modules even when a full refresh occurs.

Looking now to the server portion, it involves retrieving the developer version of the module when replacement is triggered, along with monitoring the local module sources in automatic use cases, and notifying the client in response to identifying that one or more have changed. According to an example, Node.js may be used as a websocket server configured to monitor the module source files. A websocket message may thereby be sent to the client in response to a module being modified, the message including the URL of the modified module. The client may be able to decide whether to trigger the update or not in some approaches.

It should also be noted that each module may be updated individually or as a cluster from a browser. In one example, the extension provides a simple UI that achieves this functionality by providing buttons configured to trigger individual or global updates in response to being activated, e.g., by a developer. This on-demand mode gives the change to developers to practice their test-driven-development before actually verifying their logic in the browser.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on-demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A computer-implemented method (CIM), comprising:
receiving, from a user, an identification (ID) and a Uniform Resource Locator (URL) of a first module to be updated in an Integrated Development Environment (IDE);
storing the ID and URL for the first module in local storage;
in response to the first module being updated in the IDE, automatically receiving a websocket message with a new URL for the updated first module; and
using the websocket message to initiate an updating process for the updated first module.

2. The CIM of claim 1, wherein the IDE is configured for JavaScript® software development.

3. The CIM of claim 1, wherein performing the updating process for the updated first module includes:
unregistering the first module; and
force fetching a new module source file in the IDE for the updated first module.

4. The CIM of claim 1, further comprising:
receiving an ID and a URL of a second module to be updated in the IDE;
in response to the second module being updated in the IDE, determining whether the updating process should be initiated for the updated second module;
in response to determining that the updating process should be initiated for the updated second module, requesting the updated second module; and
using the updated second module to initiate the updating process.

5. The CIM of claim 4, wherein the determining whether the updating process should be initiated for the updated second module includes:
requesting authorization from the user to initiate the updating process for the updated second module; and
in response to receiving authorization from the user, initiating the updating process for the updated second module.

6. The CIM of claim 5, wherein the requesting of the authorization from the user to initiate the updating process for the updated second module includes: causing a display to present at least one logical button to the user, the logical button being configured to initiate the updating process in response to being activated by the user.

7. The CIM of claim 4, wherein the updated second module is received from the IDE.

8. The CIM of claim 1, further comprising:
receiving, from the user, IDs and URLs of a bundle of modules to be updated in the IDE;
in response to the bundle of modules being updated in the IDE, automatically receiving a websocket message with new URLs for the bundle of updated modules; and
using the websocket message to initiate an updating process for each of the updated modules in the bundle.

9. A computer program product (CPP), comprising:
a set of one or more computer-readable storage media; and
program instructions, collectively stored in the set of one or more storage media, for causing a processor set to perform the following computer operations:
receive, from a user, an identification (ID) and a Uniform Resource Locator (URL) of a first module to be updated in an Integrated Development Environment (IDE);
store the ID and URL for the first module in local storage;
in response to the first module being updated in the IDE, automatically receive a websocket message with a new URL for the updated first module; and
use the websocket message to initiate an updating process for the updated first module.

10. The CPP of claim 9, wherein the IDE is configured for JavaScript® software development.

11. The CPP of claim 9, wherein performing the updating process for the updated first module includes:
unregistering the first module; and
force fetching a new module source file in the IDE for the updated first module.

12. The CPP of claim 9, wherein the program instructions are for causing the processor set to further perform the following computer operations:
receive an ID and a URL of a second module to be updated in the IDE;
in response to the second module being updated in the IDE, determine whether the updating process should be initiated for the updated second module;
in response to determining that the updating process should be initiated for the updated second module, requesting the updated second module; and
use the updated second module to initiate the updating process.

13. The CPP of claim 12, wherein the determining whether the updating process should be initiated for the updated second module includes:
requesting authorization from the user to initiate the updating process for the updated second module; and
in response to receiving authorization from the user, initiating the updating process for the updated second module.

14. The CPP of claim 13, wherein the requesting of the authorization from the user to initiate the updating process for the updated second module includes: causing a display to present at least one logical button to the user, the logical button being configured to initiate the updating process in response to being activated by the user.

15. The CPP of claim 12, wherein the updated second module is received from the IDE.

16. The CPP of claim 9, wherein the program instructions are for causing the processor set to further perform the following computer operations:
receive, from the user, IDs and URLs of a bundle of modules to be updated in the IDE;
in response to the bundle of modules being updated in the IDE, automatically receive a websocket message with new URLs for the bundle of updated modules; and
use the websocket message to initiate an updating process for each of the updated modules in the bundle.

17. A computer system (CS), comprising:
a processor set;
a set of one or more computer-readable storage media;
program instructions, collectively stored in the set of one or more storage media, for causing the processor set to perform the following computer operations:
receive, from a user, an identification (ID) and a Uniform Resource Locator (URL) of a first module to be updated in an Integrated Development Environment (IDE);
store the ID and URL for the first module in local storage;
in response to the first module being updated in the IDE, automatically receive a websocket message with a new URL for the updated first module; and
use the websocket message to initiate an updating process for the updated first module.

18. The CS of claim 17, wherein performing the updating process for the updated first module includes:
unregistering the first module; and
force fetching a new module source file in the IDE for the updated first module.

19. The CS of claim 17, wherein the program instructions are for causing the processor set to further perform the following computer operations:
receive, from the user, IDs and URLs of a bundle of modules to be updated in the IDE;
in response to the bundle of modules being updated in the IDE, automatically receive a websocket message with new URLs for the bundle of updated modules; and
use the websocket message to initiate an updating process for each of the updated modules in the bundle.

20. The CS of claim 19, wherein the bundle of modules includes a plurality of asynchronous module definition (AMD) based modules.
